(19) United States
(12) Patent Application Publication
(10) Pub. No.: US 2002/0167497 A1
(43) Pub. Date: Nov. 14, 2002

(54) Proof annotation system and method

(76) Inventors: Jeffrey D. Hoekstra, St. Paul, MN (US); Donald Atkinson, Mound, MN (US); Chris Rywelski, Edina, MN (US)

Correspondence Address: FAEGRE & BENSON LLP, 2200 Wells Fargo Center, 90 South Seventh Street, Minneapolis, MN, 55402-3901, US

(21) Appl. No.: 10/023,057

(22) Filed: Dec. 17, 2001

Related U.S. Application Data
(60) Provisional application No. 60/290,697, filed on May 14, 2001.

(51) Int. Cl. G09G 5/00

(52) U.S. Cl. 345/179

(57) ABSTRACT

A proof annotation method including positioning a hard proof on a proofing surface at a first location. Analog proofing comments are applied to the hard proof. The analog proofing comments are recorded using at least one sensor. The analog proofing comments are converted to digital proofing comments. The digital proofing comment are superimposed over a digital version of the hard proof and displayed on a monitor. The digital proofing comments are electronically transferred from the first location to a second location. The digital proofing comments superimposed over a digital version of the hard proof can then be viewed at the second location.

### CROSS-REFERENCE TO RELATED APPLICATIONS

The present application claims priority of U.S. Provisional application serial No. 60/290,697 filed May 14, 2001.

### FIELD OF THE INVENTION

The present invention relates to a proof annotation system, and in particular, to a system that digitizes analog proofing comments made on a hard proof for electronic distribution as a digitized proofing comment file that can be used with a digital version of the hard proof.

### BACKGROUND OF THE INVENTION

Printing processes typically involve the creation of one or more proofs that allow the printer or printing customer to view an accurate representation of the final printed product to determine if words are spelled correctly, if images are located as desired, if colors have been reproduced satisfactorily, and the like. There are multiple points in the printing process where an image or composite of images may be critiqued. For example, proofs are typically made immediately after the color scanning process, after color scan corrections are made and then again for the final composite proof. Of course, every adjustment requires another proof to show the effect of the changes. Proofing is a time-and-material consuming step in the printing process, but is traditionally considered to be necessary so that alterations and/or corrections, often at the last minute, can be checked, verified, and/or carried out.

There are two general categories of proofs: hard proofs and soft proofs. A hard proof is a substrate containing an image. A soft proof is a digital image displayed on a computer monitor.

There are three general categories of hard proofs: press proofs, analog hard proofs and digital hard proofs. Press proofs are made on the printing press used to print the job. Specifically, plates are made from composed films and one or more proofs are printed using the plate, ink and paper of the job. Such proofs are as close as possible to the output to be produced by the job. Alternatively, analog hard proofs can be created by sequentially exposing the four-color films onto photosensitive colored composite layers that simulate the printed sheet. Digital hard proofs are generated by printing the digital image onto a substrate using a suitable printing device, such as a high-resolution ink jet printer or a color laser printer. Digital hard proofs are increasingly becoming the proofing method of choice.

Hard proofs have a number of limitations. Hard proofs are physical articles for conveying information that must be routed between the interested parties, typically multiple times. During the proofing process, proofing comments are typically hand written on the hard proof. In most cases, the hard proof containing the proofing comments needs to be manually routed to a number of individuals for additional comments and/or approval before being sent to the image correction shop for modification. The various individuals involved in commenting, approving and modifying an image may be at different locations, further complicating and delaying the proofing process. In some situations the number of proofing comments is so large that readability is impaired. After each cycle of modifications, this lengthy process is often repeated before the image is ready for printing. Despite the limitations of hard proofs, this medium of communication continues to be widely used because hard proofs most closely resemble the final printed product.

Soft proofs displayed on a computer monitor have some limitations. Soft proofing often requires a specially configured and calibrated computer and a monitor. In some circumstances, soft proofs do as closely match the final printed product as a hard proofs. Rather than making proofing comments on the hard proof with a pen, the proofing comments need to be input into a computer using a mouse and a keyboard. The user interface for soft proofing systems tend to be awkward to use. All things being equal, users tend to prefer hard proofs over soft proofing.

### BRIEF SUMMARY OF THE INVENTION

The present invention relates to a proof annotation system and method. The method includes positioning a hard proof on a proofing surface at a first location. Analog proofing comments are manually applied to the hard proof. The analog proofing comments are recorded by a transcription system. The analog proofing comments are converted to digital proofing comments. The digital proofing comments are electronically transferred from the first location to one or more second locations.

In another embodiment, the digital proofing comments are displayed on a monitor at the first location and/or one or more second locations superimposed over a digital version of the hard proof. The digital version of the hard proof can be a high resolution digital image file, a low resolution digital image file, or a variety of resolutions in-between. The digital proofing comments can be electronically transferred from the first location to one or more second locations as a file, as streaming data or real-time.

In another embodiment, secondary digital proofing comments are applied to the digital version at the second location. The secondary digital proofing comments can be electronically transferred from the second location to the first location. The secondary proofing comments can be viewed at the first location superimposed over the digital version and/or the digital proofing comments. The secondary digital proofing comments are electronically transferred from the second location to the first location as a file, as streaming data or real-time.

The digital proofing comments can be stored in one or more proofing comment files separate from a digital image file corresponding to the digital version. The digital proofing comments are combined with the digital version at one or more second locations. In one embodiment, the digital proofing comments are combined with other digital proofing comments, such as those generated on a soft proofing system. In another embodiment, one or more digital proofing comment files are combined with a digital version of the hard proof to form a composite proofing file. The composite proofing file can be electronically transferred from the first location to one or more second locations. The proofing comment files can be distributed electronically to one or more users on a private network or a public network.

In one embodiment, at least one modification type corresponding to the digital proofing comments is made to at least a portion of the digital version. The modifications are preferably saved as a script file. The script file is electronically transferred from the second location to the first location such that application of the script file to a high resolution digital image of the hard proof at the first location produces a corrected high resolution digital image.

In one embodiment, the digital proofing comments can be simultaneously transmitted to and used by multiple image correction experts. The modifications made by the image correction experts can be combined into a single file or applied sequentially as separate files to the digital version to produce the corrected high-resolution digital image.

In one embodiment, the method includes a proofing menu from which a modification type to the hard proof can be selected. The location of the modification on the hard proof is recorded in the transcription system. The monitor displays a symbol, such as text or other indicia, corresponding to the desired modification. In this embodiment, the transcription system converts the analog proofing comments to text or some other symbol for display on a monitor. In another embodiment, description of the analog proofing comments can be entered using a keyboard or other input device.

In another embodiment, audio and/or video data corresponding to the analog proofing comments is recorded. The audio and/or video data is electronically transferred from the first location to the second location. The audio and/or video data can be played back at the second location. In one embodiment, the play back of the audio and/or video data is synchronized with play back of the digital proofing comments. The audio and/or video data typically corresponds to a narrative describing the analog proofing comments. The present system can also automatically generate a log of the digital proofing comments. In another embodiment, the transcription system is used to record one or more color values corresponding to a particular location on the hard proof. The recorded color values are displayed on the monitor, preferably superimposed on the digital version of the hard proof. The location on the digital version corresponding to where the color value was recorded on the hard proof is also displayed. The transcription system can be used to select a location on the hard proof. The monitor can then display a color value on the digital version at the selected location.

The transcription system can also include a bar code reader. Once a bar code on the hard proof is scanned, the monitor automatically displays the digital version of the hard proof.

The present system is also directed to a proof annotation system for a hard proof. The system includes a transcription system having an input device at a first location. A processor is coupled to or part of the transcription system. The processor is programmed to convert analog proofing comments generated using the input device to digital proofing comments and to superimpose the digital proofing comments with a digital version of the hard proof on a monitor.

In another embodiment, the digital proofing comments are displayed on a monitor at a first location and/or one or more second locations superimposed over a digital version of the hard proof. The digital proofing comments can be electronically transferred from the first location to one or more second locations as a file, as streaming data or real-time.

A processor at the second location can be used to record on the digital version secondary digital proofing comments and to electronically transfer the secondary digital proofing comments from the second location to the first location. The secondary digital proofing comments are preferably transferred from the second location to the first location in real-time or as streaming data.

The processor preferably stores the digital proofing comment in one or more proofing comment files separate from a digital image file corresponding to the digital version. The digital proofing comment files can be combined with the digital version of the hard proof to form a composite proofing file. In one embodiment, the digital proofing comments are combined with digital proofing comments not generated by the present proof annotation system. The composite proofing file can be electronically transferred from the first location to one or more second locations. The processor can be connected to a private network or a public network. In one embodiment, the second location comprises an image correction shop.

In one embodiment, the processor at a second location is adapted to perform at the second location at least one modification corresponding to the digital proofing comments on at least a portion of the digital version, to save instructions representing the modification as a script file, and to electronically transfer the script file from the second location to the first location. Application of the script file to a high resolution digital image of the hard proof at the first location produces a corrected high resolution digital image reflective of the digital proofing comments. Examples of typical modifications include text editing, color correction and retouching.

The input device is adapted to record the location of one or more registration marks on the hard proof. The processor uses the registration mark data to register the hard proof to the digital version. The input device may or may not include a writing element.

In one embodiment, the transcription system includes a proofing menu having one or more modification types to the hard proof. The processor is adapted to display on the monitor a symbol corresponding to the modification types.

In another embodiment, an audio and/or video data recording device is coupled to the processor. The processor is adapted to electronically transfer audio and/or video data from the first location to the second location. The processor at the second location can play back the audio and/or video data. In one embodiment, the play back of the audio and/or video data is synchronized with the play back of the digital proofing comments. The audio and/or video data typically comprises a narrative describing the analog proofing comments. In another embodiment, the processor automatically generates a log of the digital proofing comments. The log can be used to inventory the digital proofing comments in a form suitable for business databases and production control purposes.

In another embodiment, the input device includes a color spectrophotometer. The processor can record one or more color values on the hard proof and record the location on the hard proof from where the color values were obtained. The processor can display on the monitor the color values superimposed on the digital version of the hard proof. The processor can also display on the monitor a color value for the digital version corresponding to a location on the hard proof identified using the input device.

A bar code reader can be coupled to the processor. The processor automatically displays the digital version of the hard proof corresponding to a bar code on the hard proof.

### BRIEF DESCRIPTION OF THE SEVERAL VIEWS OF THE DRAWING

FIG. 1 is a schematic illustration of a proofing annotation system in accordance with the present invention.

FIG. 2 is a schematic illustration of an alternate proofing annotation system in accordance with the present invention.

FIG. 3 is a schematic illustration of a system and method for distributing digital proofing comments in accordance with the present invention.

### DETAILED DESCRIPTION OF THE INVENTION

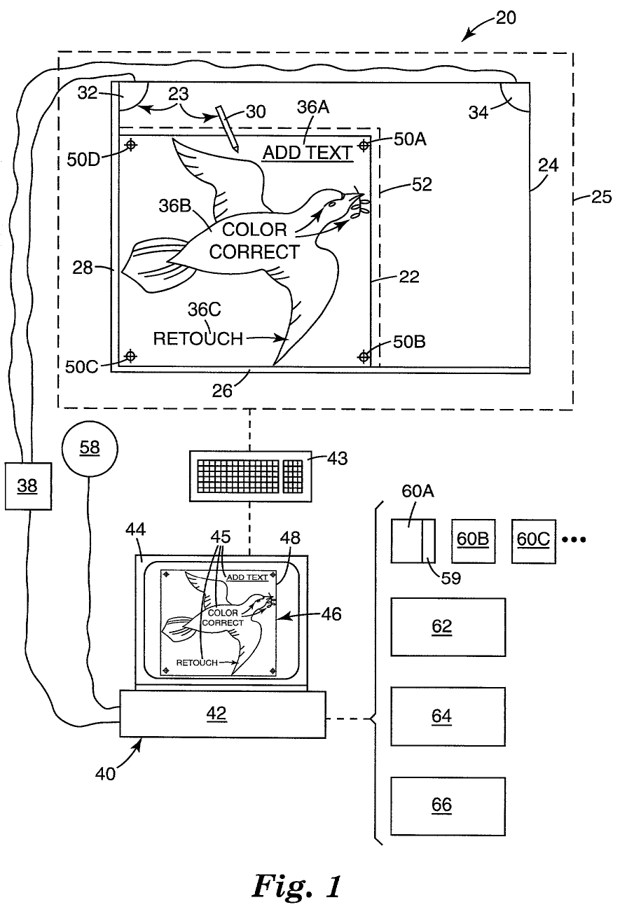

FIG. 1 is a schematic illustration of a proof annotation system 20 in accordance with the present invention. The proof annotation system 20 includes an analog-to-digital annotation system 25 and a processor 40. Processor 40 is typically a computer workstation. Alternatively, the processor 40 can optionally be incorporated into the analog-to-digital annotation system 25.

Hard proof 22 is typically located on proofing surface 24. The proofing surface 24 is preferably located in a proofing booth. Alternatively, the proofing surface 24 can be a table top or a white board. In one embodiment, reference guides 26, 28 are provided so that the hard proof 22 can be accurately repositioned on the proofing surface 24. The reference guides 26, 28 allow the hard proof 22 to be picked-up and handled during the proofing process and placed accurately back on the proofing surface 24 after handling. As used herein, “hard proof” refers to an image applied to a substrate, such as paper or a polymeric film.

In another embodiment, a system of registration pins are provided on the proofing surface 24. Corresponding holes in the hard proof 22 are created and engaged with the registration pins to register the hard proof 22 with the analog-to-digital annotation system 25. The registration pins can also be used for registering one or more transparent sheets 52 with the hard proof 22.

The proof annotation system 20 includes a transcription system 23 adapted to receive analog inputs. In the illustrated embodiment, the transcription system 23 includes one or more sensors 32, 34 and an input device or stylus 30. Sensors 32, 34 record the motion of the stylus 30 and transmit motion data to interface 38. Motion data refers generally to the location of the stylus 30 relative to the sensors 32, 34, pressure between the stylus 30 and the hard proof 22, angle of incidence of the stylus 30 relative to the hard proof 22 and/or proofing surface 24, and the like. In another embodiment, items 32, 34 and 38 can be combined into a single device. In an alternate transcription system 23, the sensors 32, 34 and the stylus 30 can be combined in a single device. As used herein, “transcription system” refers to a device that converts analog input into digital data. The transcription system preferably converts the analog input into digital data on a real-time basis.

Various transcription systems 23 can be used to capture analog proofing comments applied to a hard proof. A product sold under the trade name MIMIO available from Virtual Ink Corporation of Cambridge, Mass. and further described in U.S. Pat. Nos. 6,104,387 (Chery, et al) and 6,191,778 (Chery, et al) is suitable for this purpose. Alternate technologies for capturing and storing analog proofing comments include digitized writing surfaces such as electronic whiteboards or SMARTBOARDS®. These electronic whiteboards typically either photocopy an entire writing surface or serve as the actual input device (e.g. an electronic template) for capturing the handwritten data. The whiteboards may be active or passive electronic devices where the user writes on the surface with a special stylus. The active devices may be touch sensitive, or responsive to a light or laser pen wherein the whiteboard is the detector that detects the active signal. Other transcription devices suitable for the present invention include the Intuos2 available from Wacom Technology Co. of Vancouver, Wash.; the GridMaster Flexible Digitizing Mat available from Numonics Corporation of Montgomeryville, Pa.; the Roll-Up II and Cordless Roll-Up Digitizer Series available from GTCO Corporation of Columbia, Md.; and the DataFlex II Large Format Flexible Digitizer Systems available from Altek Corporation of Silver Springs, Md.

In the illustrated embodiment, the stylus 30 is used to apply analog proofing comments 36A, 36B, 36C (referred to collectively as “36”) to the hard proof 22. The analog proofing comments 36 can be pen strokes made using the stylus 30 on the hard proof 22 or on one or more transparent films 52 overlaying the hard proof 22.

In the illustrated embodiment, the stylus 30 includes a housing adapted to retain a writing element, such as a felt tipped marker, so that the analog proofing comments 36 are visible on the hard proof 22. The stylus 30 also includes a contact switch for sensing when the stylus 30 is in contact with the hard proof 22 and a position signal transmitter for transmitting a plurality of position signals when the stylus 30 is sensed by the contact switch to be in contact with the hard proof 22. In another embodiment, the stylus 30 does not include a writing element. The user traces the analog proofing comments 36 without making marks on the hard proof 22 or the film 52. In this embodiment, a monitor 44 is preferably provided to view the analog proofing comments in real-time, as will be discussed below.

In another embodiment, the stylus 30 can be used to identify a location on the hard proof 22 where the analog proofing comments 36 should be located, but a description of the actual proofing comments 36 are recorded using keyboard 43 attached to the processor 42, the transcription system 23, and/or the analog-to-digital annotation system 25. The actual text of the proofing comments would appear as digital proofing comments 45 on the monitor 44. The digital proofing comments 45 generated using the present system can also be combined and displayed with digital proofing comments generated by other sources, such as for example a soft proofing system.

The analog proofing comments 36 instruct an image correction expert, an image correction shop and/or a printer to make modifications to an image. For example, proofing comment 36A indicates that text should be added at a particular location. Proofing comment 36B is an instruction to correct color at two locations. Proofing comment 36C indicates retouching is required in a particular location. As used herein, “analog proofing comments” refer to text, symbols or any other indicia applied to, or traced on, a hard proof or to a transparent sheet overlying the hard proof that communicates required modifications. The analog proofing comments may or may not involve forming visible marks on the hard proof or overlay.

Optional a transparent sheet 52, such as an acetate sheet, can be placed over the hard proof 22. Analog proofing comments 36 made with the stylus 30 are still recorded by the sensors 32, 34, but the physical marks made by the writing element in the stylus 30 are applied to the transparent sheet 52, not the hard proof 22. Consequently, multiple sets of analog proofing comments 36 can be made on multiple transparent sheets 52, without the hard proof 22 being damaged. As used herein, “applying analog proofing comments” refers to marking or otherwise indicating the analog proofing comments directly to the hard proof or to a transparent sheet overlaying the hard proof. As discussed above, the analog proofing comments may or may not be visible on the hard proof 22.

In some applications, the quantity of analog proofing comments 36 may be sufficiently large that at some point the comments are no longer readable. In such a situation, multiple sets of analog proofing comments 36 are recorded on separate transparent sheets 52. For example, each person supplying analog proofing comments 36 could use a different transparent sheet 52. Alternatively, each class of analog proofing comments 36 can be applied to a different transparent sheet 52. For example, all color correction comments may be located on a single transparent sheet 52. Each group of analog proofing comments 36 may be recorded in processor 40 as a different file or layer of comments, as will be discussed in more detail below.

Interface 38 converts motion data corresponding to movement of the stylus 30 on the hard proof 22 into digital proofing comments 45. Alternatively, the motion data can be converted to digital proofing comments 45 at processor 40. The digital proofing comments 45 displayed on monitor 44 correspond substantially to the analog proofing comments 36 made on the hard proof 22. In another embodiment, the digital proofing comments 45 appear on a monitor at a second location, discussed in detail below.

As the analog proofing comments 36 are applied to the hard proof 22, they preferably simultaneously appear on the monitor 44 superimposed over the a digital version 46 of the hard proof 22. The digital proofing comments 45 are preferably displayed on the monitor 44 in real-time. As used herein, “digital version” refers to any digital image representing the hard proof, including without limitation a high or a low resolution digital composite of one or more native (i.e., original) files from which the hard proof is derived, a post-script file, or a proxy image file representing the native files or the hard proof made from the native files. The digital version 46 is preferably a post raster image processor file (RIP) used by the hard proof generating device because it most closely resembles the hard proof.

The composite digital proof 48 displayed on the monitor 44 corresponds to the digital version 46 of the hard proof 22 containing the analog proofing comments 36. The composite digital proof 48 can be a single file combining the digital proofing comments 45 and the digital image file 46 (composite proofing file) or an overlay of multiple separate files.

The digital proofing comments 45 are preferably a separate layer that is superimposed on top of the digital version 46. In one embodiment, the digital proofing comments 45 comprise an annotation layer to a (*.pdf) format image file. Digital proofing comments 45 can be stored in processor 40 as one or more proofing comment files 60A, 60B, 60C (referred to collectively as “60”) separate from either a high resolution image file 62 or a low resolution image file 64. Alternatively, the proofing comments file 60 and the digital version 46 can be combined into a single composite digital proofing file 66. Where a large number of analog proofing comments 36 need to be annotated or the layout of the hard proof 22 is complex, multiple proofing comment files 60 are preferably used.

In another embodiment, soft proofing comments generated using conventional soft proofing techniques can be combined with the digital proofing comments 45 generated using the present system. Since the soft proofing comments are already in a digital format, no conversion is required. The soft proofing comments can be a separate file or combined with the digital proofing comments 45 generated using the present system.

Separating the digital proofing comments 45 into separate proofing comment files 60 increases readability. For example, the proofing comment files 60A, 60B, 60C, . . . can be viewed by the image correction expert one at a time (in any order), simultaneously and/or sequentially. In another embodiment, the digital proofing comments 45 for a certain region or area of the digital proof 46 can be viewed, to the exclusion of digital proofing comments in other areas of the digital proof 46. In yet another embodiment, the digital proofing comments 45 contained in a particular proofing comment file 60 can be played back in the order they were recorded or in reverse order.

Separating the digital proofing comments 45 into separate proofing comment files 60 also allows for selective distribution. Certain proofing comment files 60 can be transmitted to some individuals, but not others. For example, a proofing comment file 60 containing color correction modifications can be sent to the color correction expert, while the proofing comment file 60 containing retouching comments can be sent to the retouching expert.

In the illustrated embodiment, the hard proof 22 includes a plurality of registration marks 50A, 50B, 50C, 50D (collectively referred to as “50”). The registration marks 50 are useful in aligning the analog proofing comments 36 with the digital version 46 on the monitor 44.

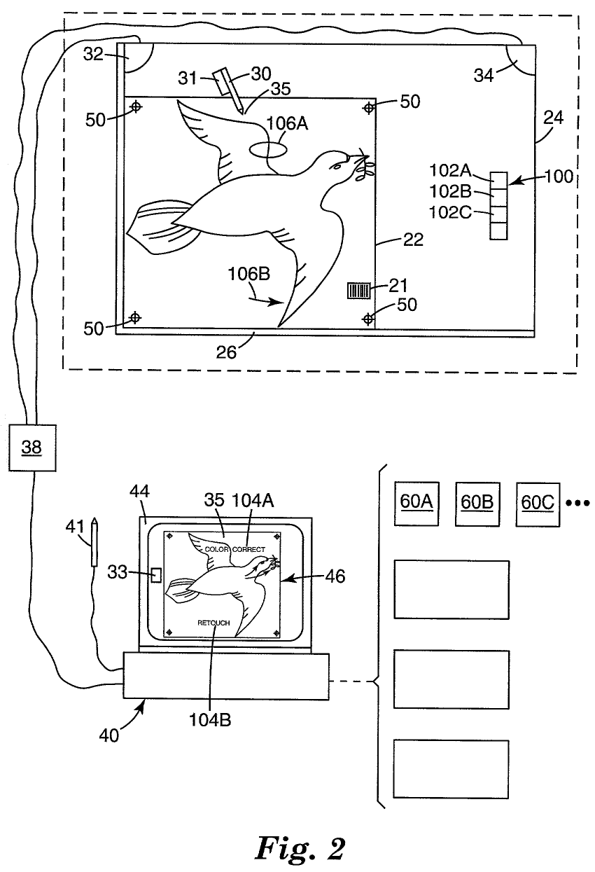

In one embodiment of the present method, the hard proof 22 is located on the proofing surface 24 against the reference guides 26, 28. The stylus 30 is then sequentially positioned at one or more of the registration marks 50 so that the processor 40 can record the location of the registration marks 50 relative to the proofing surface 24. Stylus 30 is then used to apply a variety of analog proofing comments 36 to the hard proof 22. Central processing unit 42 correlates the position of the digital version 46 with analog proofing comments 36. In another embodiment, collecting motion data for the registration marks 50 is one of the options in the proofing menu 100 (see FIG. 2).

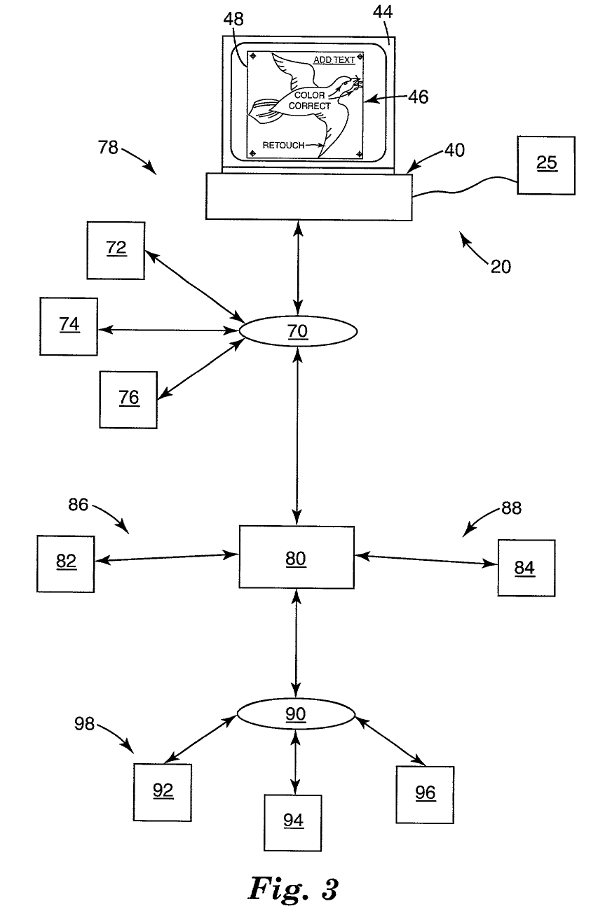

In another embodiment, an audio and/or video data recording device 58 is optionally provided to record audio and/or video data 59 related to the analog proofing comments 36. For example, the individual making the analog proofing comments 36 can provide a narrative related to the analog proofing comments 36 as they are generated using the stylus 30. The audio and/or video data 59 is preferably digitized and combined with one or more of the proofing comment files 60. This audio and/or video data 59 can then be distributed electronically along with the digital proofing comments 45. In one embodiment, the proofing comment files 60 and the audio and/or video data 59 are distributed to one or more remote locations 72, 82, 92 (see FIG. 3). The digital proofing comments 45 and the audio and/or video data 59 are preferably synchronized for simultaneous play back, although the audio and/or video data 59 can be played back separately from the digital proofing comments 45.

Once the analog proofing comments 36 are captured, the digital proofing comments 45 can be simultaneously transmitted to one or more uses at one or more locations as a file, as streaming data, or as real-time data. The proofing comment file 60 can be sent to other users as one or more separate files or a single composite file. The low resolution image file 64 can also be sent. Subsequent users combine the proofing comment file 60 with the low resolution file image 64 in order to view the composite digital image 48. In another embodiment, the low resolution image file 64 and the proofing comments file 60 are combined at the processor 40 and sent to other users as a composite digital proof file 66. In some applications, the high resolution digital image file 62 is sent with the proofing comment file(s) 60. Conventional systems for distributing soft proofing comments can be used to distribute the digital proofing comments 45 of the present invention.

As used herein “streaming data” technology refers to the continuous transfer of data from a source to a destination (or target). For example, the Real-time Protocol (RTP) delivers real-time content over the Internet (or other networks based on an IP protocol) for use with real-time applications. Typically, a separate protocol, the Real-Time Control Protocol (RTCP) is used with RTP to pass control messages for session management, rate adaptation and the like. Various embodiments of stream data technology are further disclosed in U.S. Pat. Nos. 5,473,755 (Dunning); 5,918020 (Blackard et al.); and 5,928,331 (Bushmitch). A variety of streaming data products are commercially available. RealTimeImage of San Bruno, Calif. offers an imaging technology called Pixels-On-Demand that streams real-time, full-resolution images, even over a 56k Internet connection.

In an alternate embodiment illustrated in FIG. 2, the stylus 30 can be used to select a category of proofing comments from a proofing menu or virtual ink well 100. The proofing menu 100 identifies one or more modification types 102A, 102B, 102C (referred to collectively as “102”) commonly indicated on the hard proof 22, such as for example color correction 102A , retouching 102B, adding/deleting text 102C, and the like. The proofing menu 100 can be located on the proofing surface 24 or on the hard proof 22, typically outside the image perimeter defined by registration marks 50. The operator selects a modification type 102 using the stylus 30 and uses the stylus 30 to apply the selected analog proofing comments 106A, 106B (referred to collectively as “106”) to the region on the hard proof 22 requiring the selected modification. In another embodiment, the proofing menu is located on the stylus 30, typically as a series of switches adapted to select a particular modification type. In yet another embodiment, a proofing menu 100 is located on the monitor 44. The user selects a modification type 102 using the keyboard 43 or some other input device.

The analog proofing comments 106 can be virtually any type of indicia. For example, in the embodiment of FIG. 2, the analog proofing comment 106A is a circle or boundary marker drawn using the stylus 30 to define where a color correction is required. The processor 40 then automatically generates digital proofing comments in the form of text 104A or symbols or other indicia in the corresponding location on the digital version 46 of the hard proof 22. The digital proofing comments 104A, 104B correspond to one or more of the modification type 102A, 102B, and 102C selected using the stylus 30.

For example, as illustrated in FIG. 2 the operator selected color correction modifications 102A and circled the area on the hard proof 22 where the color correction was needed. The motion data generated by analog proofing comments 106A are recorded by the sensors 32, 34. The processor 40 converts the analog proofing comment 106A to digital proofing comments 104A that correspond to the color correction 102A and the location on the hard proof 22 where the color correction is needed. In the illustrated embodiment, the processor 40 automatically inserts a text message 104A indicating the location and nature of the required modification. Each category of modification 102 recorded using the stylus 30 is preferably stored in a separate proofing comment file 60. In another embodiment, the modification 102 can be displayed by symbols or indicia other than the text message.

In another embodiment, the present proof annotation system 20 generates a log of the digital proofing comments 45. The log can be generated based upon the type of modifications selected from the proofing menu 100 or can rely on hand-writing recognition software to classify the modifications requested using the transcription system 23. This log can be used, for example, for time and billing purposes to track modifications made to the high resolution digital image.

In yet another embodiment illustrated in FIG. 2, the stylus 30 includes a color spectrophotometer 31 that is adapted to measure colors on the hard proof 22. The analog-to-digital annotation system 25 records a location of the stylus 30 on the hard proof 22, such as for example location 35. The spectrophotometer on the stylus 30 records the color value 33 on the hard proof 22 at the location 35. The corresponding location 35 of the stylus 30 on the digital version 46 is then displayed on the monitor 44 along with the color value 33. The color value 33 can be displayed at the location 35 or outside the boarder of the digital version 46. Color value 33 is typically in a particular color space or coordinate system, such as RGB, YCC, CMYK, or LAB.

In still another embodiment, the color value 33 of the digital version 46 for a particular location 35 can be displayed on the monitor 44. Each pixel of the digital version 46 is assigned a color value in a particular color space. The stylus 30 is used to select a location (e.g., location 35) on the hard proof 22. The analog-to-digital annotation system 25 records the location of the stylus 30 on the hard proof 22. The corresponding location 35 of the stylus 30 on the digital version 46 is displayed on the monitor 44 along with the color value 33 of the digital version 46 at that location 35. Again, the color value 33 can be displayed at the location 35 or outside the boarder of the digital version 46.

Also illustrated in FIG. 2, the hard proof 22 optionally includes a bar code or other machine readable indicia 21. Bar code reader 41 is coupled to the processor 40 to read the bar code 21. The bar code 21 prompts the processor 40 to retrieve the correct digital version 46 of the hard proof 22. In one embodiment, the bar code reader 41 is combined with the stylus 30, such as at the location 31.

As illustrated in FIG. 3, processor 40 is typically attached to a private network 70 at first location 78. Private network 70 typically include a series of additional processors or work stations 72, 74, 76, any or all of which may receive the proofing comment file 60 and/or one of the image files 62, 64. Distributing the proofing comment file 60 and/or the composite digital proofing file 66 over the private network 70 obviates manually routing the hard proof 22 to the other users. The private network 70 can be a local area network (LAN), such as an Ethernet LAN or a token ring LAN, an Intranet, an Extranet, or a Virtual Private Network (VPN).

In one embodiment, local users at processors 72, 74, 76 are image correction experts assigned to perform the modifications indicated by the proofing comment file 60. Users at processor 72, 74, 76 can simultaneously view the digital proofing comments 45 either alone or in combination with a digital version 46 of the hard proof 22 and make the requested modifications. In one embodiment, the user at processor 72 performs retouching, the user at processor 74 performs color correction, and the user at processor 76 performs text editing. As used herein, “modifications” refers to global or pixel level corrections or adjustments made to an image file that may include, but are not limited to, exposure correction, neutralizing color casts, optimization of reproduction range, image silhouetting, color alteration, pixel editing, retouching, color space conversion, tonal adjustments, color cast correction, unsharp mask filtration, convert color space, selective color correction, edge definition.

In one embodiment, the modifications are recorded by the image correction experts in a script file. The script files generated by the image correction experts at processors 72, 74, 76 can then be combined into a single file or applied sequentially to the high resolution image file 62 to produce a corrected high resolution digital image based upon the original analog proofing comments 36. After the script files are generated, the digital image file 46, 60 and/or 62 can be discarded by the users at the processors 72, 74, 76. As used herein, the term “script file” is defined as a file containing the list of instructions representing the modifications performed by the image correction specialist. A script file may include any number of global or pixel level image modification instructions. The script file may be recorded in conjunction with any number of commercially available color applications including, but not limited to, Photoshop by Adobe Systems, Inc. of San Jose, Calif.; Linocolor by Heidelberg Color Publishing Solutions, Inc. of Hauppauge, N.Y.; Live Picture by HCS Software, Inc. of Santa Monica, Calif.; Photoscripter by Main Event Software, Inc. of Washington, D.C.; Courier and Expert available from Prolatus, Inc. of Minneapolis, Minn.; the method and system disclosed in U.S. Pat. No. 6,304,277 (Hoekstra et al.); and the method and system disclosed in U.S. patent application Ser. No. 09/629,358 filed Aug. 1, 2000 entitled Remote Modification of Digital Images Using Scripts.

In another embodiment, the processor 40 sends the proofing comment file 60, the composite digital proofing file 66 and/or one of the image files 62, 64 through the private network 70 and a public network 80 to remote processors 82, 84 at second and third locations 86, 88, respectively. The remote processors 82, 84 can display the proofing comment file 60, either alone or in combination with a digital version 46 of the hard proof 22.

The remote processors 82, 84 can correspond to color correction experts, printers, customers, etc. The public network 80 can be a wide area network or the Internet. The Internet, sometimes called simply “the Net,” is a worldwide system of computer networks—a network of networks in which users at any one computer can, if they have permission, get information from any other computer (and sometimes talk directly to users at other computers). Physically, the Internet uses a portion of the total resources of the currently existing public telecommunication networks.

In yet another embodiment, the proofing comment file 60 is sent through the public network 80 to a private network 90 at a fourth location 98. The private network 90 can be an image correction shop, a printer, or a variety of other sites. Again, multiple users can review the proofing comment file 60, either alone or in combination with a digital version 46 of the hard proof 22. Where the users are image correction experts, multiple modifications to the digital image file 62, 64 to be performed simultaneously. As discussed above, users at processors 92, 94, 96 can perform a variety of modifications such as retouching, color correction, and text editing and record the modifications in the form of a script file.

The script files corresponding to the modifications can be combined and applied to the high resolution digital image file 62 to produce a corrected high resolution digital image. Alternatively, multiple script files can be applied sequentially to the high resolution digital image. The script files can be sent to any location (e.g., processor 82, 84) having access to the networks 70, 80, 90, without transmitting the digital image. In one example, proofing comments 36 are created at first location 78 (e.g., a customer site), the modification are made to the image at a second location 82 (e.g., an image correction shop) and the script files corresponding to the modifications are sent to a third location 88, such as a printer's facility, where they are applied to the high resolution digital image file 62 to produce the corrected high resolution digital image file.

In another embodiment, the digital proofing comments 45 are displayed real-time or substantially real-time at one or more other workstations 72, 74, 76, 82, 84, 92, 94, 96. Real-time proofing comments can be transmitted using streaming data and a variety of other techniques. Users at one or more of the workstations 72, 74, 76, 82, 84, 92, 94, 96 can view the real-time digital proofing comments 45 and make modifications to the digital image and/or apply secondary digital proofing comments to the digital version. These secondary digital proofing comments can be sent back to the first location, preferably real-time.

The secondary proofing comments can be made using the present proof annotation system or a variety of soft proofing systems, such as disclosed in U.S. Pat. Nos. 5,625,766 (Kauffman); 5,995,719 (Bourdead'hui et al.); 5,999,153 (Lind et al.); 6,060,208 (Wang); and 6,069,601 (Lind et al.). The present system permits multiple users at multiple remote locations to engage in a real-time collaborative proof mark-up and/or modification session.

All of the patents and patent applications disclosed herein, including those set forth in the Background of the Invention, are hereby incorporated by reference. With regard to the foregoing description, it is to be understood that changes may be made in detail, without departing from the scope of the present invention. It is intended that the specification and depicted aspects be considered exemplary only, with a true scope and spirit of the invention being indicated by the broad meaning of the following claims.

What is claimed is:

1. A proof annotation method comprising the steps of:
positioning a hard proof on a proofing surface at a first location;
applying analog proofing comments to the hard proof;
recording the analog proofing comments using a transcription system;
converting the analog proofing comments to digital proofing comments; and
electronically transferring the digital proofing comments from the first location to one or more second locations.

2. The method of claim 1 comprising displaying on a monitor the digital proofing comment superimposed over a digital version of the hard proof.

3. The method of claim 2 wherein the digital version of the hard proof comprises one of a low resolution digital image file, a high resolution digital image file, or a post raster image processor version.

4. The method of claim 1 comprising displaying on a monitor at the first location the digital proofing comment superimposed over a digital version of the hard proof.

5. The method of claim 1 comprising displaying on a monitor at the second location the digital proofing comment superimposed over a digital version of the hard proof.

6. The method of claim 1 comprising electronically transferring the digital proofing comments from the first location to one or more second locations as streaming data.

7. The method of claim 1 comprising electronically transferring the digital proofing comments from the first location to one or more second locations real-time.

8. The method of claim 1 comprising the steps of:
applying secondary digital proofing comments on the digital version at the second location; and
electronically transferring the secondary digital proofing comments from the second location to the first location.

9. The method of claim 1 wherein the step of recording analog proofing comments comprises moving an input device relative to at least one sensor.

10. The method of claim 1 comprising storing the digital proofing comment in one or more proofing comment files separate from a digital image file corresponding to the digital version.

11. The method of claim 1 comprising combining one or more digital proofing comment files with a digital version of the hard proof to form a composite proofing file.

12. The method of claim 1 comprising combining the digital proofing comments with digital proofing comments not generated by the present proof annotation system.

13. The method of claim 1 wherein the step of electronically transferring the digital proofing comments comprises distributing one or more proofing comment files to one or more users on a private network.

14. The method of claim 1 wherein the step of electronically transferring the digital proofing comments comprises distributing one or more proofing comment files to one or more users on a public network.

15. The method of claim 1 comprising electronically transferring a digital version of the hard proof to at least the second location.

16. The method of claim 1 wherein the second location comprises an image correction shop.

17. The method of claim 1 comprising the steps of:
performing at the second location at least one modification corresponding to the digital proofing comments on at least a portion of the digital version;
saving instructions representing the modification as a script file; and
electronically transferring the script file from the second location to the first location such that application of the script file to a high resolution digital image of the hard proof at the first location produces a corrected high resolution digital image.

18. The method of claim 1 comprising the step of electronically transferring the digital proofing comments to multiple image correction experts.

19. The method of claim 1 comprising the steps of:
electronically transferring the digital proofing comments to multiple image correction experts at a second location;
a first image correction expert performing a first modification on at least a portion of the digital version corresponding to a first digital proofing comment and a second image correction expert simultaneously performing a second modification on at least a portion of the digital version corresponding to a second digital proofing comment;
saving instructions representing the first and second modifications as one or more script files; and
electronically transferring the script files from the second location to the first location such that application of the script file to a high resolution digital image of the hard proof at the first location produces a corrected high resolution digital image.

20. The method of claim 19 wherein the modifications comprise one of text editing, color correction and retouching.

21. The method of claim 1 comprising the step of recording the location of registration marks on the hard proof using an input device.

22. The method of claim 1 comprising the step of combining an input device for applying analog proofing comments with a writing element.

23. The method of claim 1 wherein the step of applying an analog proofing comment comprises the steps of:
selecting from a proofing menu a modification to the hard proof;
recording the location of the modification on the hard proof in the transcription system; and
displaying on a monitor a symbol corresponding to the modification.

24. The method of claim 1 wherein the step of applying an analog proofing comment comprises the steps of:
recording a location on the hard proof using the transcription system; and
describing the analog proofing comments for that location using a keyboard.

25. The method of claim 1 comprising the steps of:
recording audio and/or video data corresponding to the analog proofing comments; and
electronically transferring the audio and/or video data from the first location to the second location.

26. The method of claim 25 comprising synchronizing play back of the audio and/or video data with play back of the digital proofing comments.

27. The method of claim 25 wherein recording audio and/or video data corresponding to the analog proofing comments comprises recording a narrative describing the analog proofing comments.

28. The method of claim 1 comprising automatically generating a log of digital proofing comments.

29. The method of claim 1 comprising the steps of:
recording one or more color values corresponding to a particular location on the hard proof using the transcription system; and
displaying the recorded color values on a monitor.

30. The method of claim 29 comprising displaying the recorded color values superimposed on a digital version of the hard proof.

31. The method of claim 29 comprising indicating on a digital version of the hard proof a corresponding location where the color value was recorded on the hard proof.

32. The method of claim 1 comprising the steps of:
selecting a location on the hard proof using the transcription system; and
displaying on a digital version of the hard proof at a corresponding location a color value.

33. The method of claim 1 comprising the steps of:
reading a bar code on the hard proof; and
automatically displaying on the monitor a digital version of the hard proof.

34. A proof annotation method comprising the steps of:
positioning a hard proof on a proofing surface at a first location;
applying analog proofing comments to the hard proof;
recording the analog proofing comments using a transcription system;
converting the analog proofing comments to digital proofing comments;
electronically transferring the digital proofing comments from the first location to at least one second location; and
viewing at the second location the digital proofing comments superimposed over a digital version of the hard proof.

35. The method of claim 34 comprising transferring the digital proofing comments from the first location to the second location real-time.

36. A proof annotation system for a hard proof comprising:
a transcription system having an input device at a first location; and
a processor coupled to the transcription system programmed to convert analog proofing comments generated using the input device to digital proofing comments and to superimpose the digital proofing comments with a digital version of the hard proof on a monitor.

37. The proof annotation system of claim 36 wherein the monitor is located a first location.

38. The proof annotation system of claim 36 wherein the monitor is located a second location.

39. The proof annotation system of claim 36 wherein the digital version of the hard proof comprises a low resolution digital image file, a high resolution digital image file, or a post raster image processor file.

40. The proof annotation system of claim 36 wherein the processor displays the digital proofing comments on the monitor in real-time.

41. The proof annotation system of claim 36 wherein the processor transfers the digital proofing comments from the first location to one or more second locations as streaming data.

42. The proof annotation system of claim 36 comprising a processor at the second location adapted to record on the digital version secondary digital proofing comments and to electronically transfer the secondary digital proofing comments from the second location to the first location.

43. The proof annotation system of claim 42 wherein the secondary digital proofing comments are transferred from the second location to the first location in real-time.

44. The proof annotation system of claim 42 wherein the secondary digital proofing comments are transferred from the second location to the first location as streaming data.

45. The proof annotation system of claim 36 wherein the processor is adapted to store the digital proofing comment in one or more proofing comment files separate from a digital image file corresponding to the digital version.

46. The proof annotation system of claim 36 wherein one or more of the digital proofing comment files and the digital version of the hard proof comprise a composite proofing file.

47. The proof annotation system of claim 36 wherein one or more of the digital proofing comment files and digital proofing comments not generated by the proof annotation system comprise a composite proofing file.

48. The proof annotation system of claim 36 wherein the processor is connected to a private network.

49. The proof annotation system of claim 36 wherein the processor is connected to a public network.

50. The proof annotation system of claim 36 wherein the processor is adapted to electronically transfer the digital version to at least the second location.

51. The proof annotation system of claim 50 wherein the second location comprises an image correction shop.

52. The proof annotation system of claim 36 comprising a processor at a second location adapted to perform at the second location at least one modification corresponding to the digital proofing comments on at least a portion of the digital version, to save instructions representing the modification as a script file, and to electronically transfer the script file from the second location to the first location such that application of the script file to a high resolution digital image of the hard proof at the first location produces a corrected high resolution digital image.

53. The proof annotation system of claim 52 wherein the modifications comprise one of text editing, color correction and retouching.

54. The proof annotation system of claim 36 wherein the processor is adapted to electronically transfer the digital proofing comments to multiple image correction experts.

55. The proof annotation system of claim 36 wherein the input device is adapted to record the location of one or more registration marks on the hard proof.

56. The proof annotation system of claim 36 wherein the input device comprises a writing element.

57. The proof annotation system of claim 36 wherein the transcription system comprises a proofing menu having one or more modification types to the hard proof.

58. The proof annotation system of claim 57 wherein the processor is adapted to display on the monitor a symbol corresponding to the modification types.

59. The proof annotation system of claim 36 comprising a keyboard for describing analog proofing comments made using the transcription system.

60. The proof annotation system of claim 36 comprising an audio and/or video data recording device coupled to the processor, wherein the processor is adapted to electronically transfer audio and/or video data from the first location to the second location.

61. The proof annotation system of claim 60 comprising a processor at the second location adapted to synchronize play back of the audio and/or video data with play back of the digital proofing comments.

62. The proof annotation system of claim 60 wherein the audio and/or video data comprises a narrative describing the analog proofing comments.

63. The proof annotation system of claim 36 wherein the input device comprises a color spectrophotometer.

64. The proof annotation system of claim 63 wherein the processor is adapted to record one or more color values on the hard proof and to record the location on the hard proof from where the color values were obtained.

65. The proof annotation system of claim 64 wherein the processor is adapted to display on the monitor the color values superimposed on the digital version of the hard proof.

66. The proof annotation system of claim 36 wherein the processor is adapted to display on the monitor a color value for the digital version corresponding to a location on the hard proof identified using the input device.

67. The proof annotation system of claim 36 comprising a bar code reader coupled to the processor, the processor being programmed to automatically displaying the digital version of the hard proof corresponding to a bar code on the hard proof.

68. The proof annotation system of claim 36 comprising a log automatically generated by the processor of the digital proofing comments.
